(19) United States
(12) Patent Application Publication
(10) Pub. No.: US 2009/0133325 A1
(43) Pub. Date: May 28, 2009

(54) Cover for deflecting light and minimizing heat absorption by a body

(75) Inventor: Mark N. Kraminer, Westmount (CA)

Correspondence Address: THE NATH LAW GROUP, 112 South West Street, Alexandria, VA, 22314, US

(73) Assignee: WORKMAN PACKAGING INC.,, Quebec (CA)

(21) Appl. No.: 11/984,868

(22) Filed: Nov. 23, 2007

(51) Int. Cl. A01G 13/02

(52) U.S. Cl. 47/31.1

(57) ABSTRACT

Disclosed is a cover devised to be positioned on a body, especially sod, in order to deflect light and to minimize the build up of heat under the cover, while retaining moisture so as to not to hasten the decay of the body. This cover comprises an inner surface which contacts the body, and an outer surface, wherein the inner surface is of an opaque dark color to minimize heat build up and the outer surface is of an opaque pale color to deflect light. The inner and outer surfaces are produced by co-extrusion. As such, the cover is specifically designed to increase the shelf-life of sod, especially during its storage and transportation.

### FIELD OF THE INVENTION

The present invention relates to a cover devised to be positioned onto a body. This cover is designed to deflect light and to minimize the build up of heat under the cover, as well as to advantageously retain the moisture of the body as to not hasten its decay, and thus to increase the shelf-life of the body during its storage and transportation.

Although reference will almost be made exclusively to sod as the body to be protected by the cover according to the invention, it is important to note that the use of this cover is not restricted to protect sod exclusively. It could actually be used with any kind of body that has to be protected from light and heat.

### BACKGROUND OF THE INVENTION

Sod is a surface layer of ground containing a matt of grass and grass roots. The term “sod” is a synonym of the term “turf”, “sward”, and “greensward”. It is known that sod generally comprises a matt of grass including the part of the soil beneath it held together by the roots, or a piece of this material.

It is also known that sod may be grown agriculturally, and may be sold to establish a lawn in a an efficient fashion. Transplanted sod may be rolled up or flat and placed onto skids for transport, storage and sale.

It is known that sod may be also used as a building material. It may be cut in blocks for use as a building material, especially in grasslands where grass is plentiful and few other materials are available. Sod may be cut out in regular block shapes and laid like brickwork, although strength blocks of sod are usually longer and wider than typical bricks.

It is also known that sod has been used in fortification. Blockhouses have been constructed from sod, and it has also been used to make very effective berms or low defensive walls.

Furthermore, it is known that sod may be used in land care and landscape architechture.

Covers for simply protecting grass or turf are known in the field. For example, U.S. Pat. No. 5,070,643 (HINSPERGER) describes a method of protecting outdoor grass areas from dessication and winter kill; for enhancing seed germination in both grass, flower and vegetable seeds; and for increasing soil temperature and stimulating early root and top growth. This method comprises encasing the area concerned with a cover comprising at least one panel of open weave scrim material formed by loosely woven thin and narrow UV stabilized strips of clear transparent plastic material having a non-uniform striped lace coating of highly ultra-violet stabilized plastic, covering less than 50% of the surface area of the scrim, permitting passage of air and moisture through the open weave of the scrim.

Similarly, US patent application 2003/0121202 (HINSPERGER), now abandoned, also describes a protective heat absorbing and heat reflective composite comprising an open mesh weave of thermoplastic material, the weave having warp and weft strips forming a substantially thin uniform layer having opposed major surfaces, the layer having on one of its surfaces a heat absorbing lace coating and on its other surface a heat reflective discontinuous or intermittent coating. However, it is to be noted the heat absorbing lace coating is positioned on the top layer of the cover to allow sunlight to permeate through it, and the heat reflective lace coating is positioned on the bottom layer to trap moisture, chemicals and heat between the substrate and the protective cover.

Another example of a protective cover for turf is found in U.S. Pat. No. 6,739,088 (STOLLER). This protective winter turf cover is formed with a layered polyethylene laminated sheet with each layer having force striations running at an angle to the edge of the sheet and with the force striations of one layer at an angle to the force striations of the adjacent layer, the resulting turf cover being lightweight, compactly foldable, and substantially impermeable to water. This cover is impermeable to water and is ultra white in color in order to substantially delay either rapid cooling or rapid warming of the surface that is covered because the ultra white color reflects sunlight and delays heating.

Mulching films used as coverings are also known in the art. For example, U.S. Pat. No. 4,920,692 (KITAMURA ET AL.) describes mulching films designed to inhibit the raising of the underground temperature, repel insects, and prevent the propagation of weeds. This mulching film comprises a reflective film layer and a black film layer which is effective for repelling insect pests harmful for various crops and other plants by covering ground for plantation and for lowering of the underground temperature and also for the prevention of the propagation of weeds.

Another type of agricultural mulch film is provided in U.S. Pat. No. 5,729,929 (BURKE) which comprises a multilayered co-extruded film, comprising at least one heat absorptive or black film layer with a substantially central white, silver or reflective layer on at least one side of the film.

However, none of these films or covers are designed to cover sod, or harvested agricultural products, in order to increase their shelf-life during storage and transportation. Furthermore, the objective of minimizing the build up of heat under the cover is not specifically targeted by the prior art documents discussed herein above, nor is their objective to contain a certain level of moisture within the covered body as to not hasten its decay.

One of the problems associated with the commercialization of sod is that it is marketed on a turn around of twenty four hours from the time it is harvested. In fact, it is known that sod has a short shelf life. Indeed, sod is generally stacked outdoors, and after approximately 24 hours of being exposed to the elements, sod begins to lose moisture content, or to dry, to burn, and/or to turn yellow. As the sod turns yellow, it is less suitable for sale since yellow sod is less attractive to the consumer and indicates that it is becoming too dry to re-plant successfully.

The current procedure dictates for the sod to be re-planted as soon as possible, usually within 24 hours from the time that the sod was harvested. This time constraint for the successful re-planting of sod is greatly limiting sod commercialization.

Hence, in light of the aforementioned, there is a need for a cover, which, by virtue of its design and its components, would be able to overcome the above-discussed problems.

### SUMMARY OF THE INVENTION

The present invention is directed to a cover to be positioned onto a body, especially sod, to deflect light and to minimize heat absorption by the body. The cover also advantageously retains the moisture of the body, so as to not hasten its decay.

This cover which overcomes the above-mentioned problems basically comprises an inner surface which contacts the body and an outer surface, wherein the inner surface is of an opaque dark color to minimize heat build up and the outer surface is of an opaque pale color to deflect light. This increases the shelf-life of the body, especially during its storage and transportation, especially by keeping the moisture of the body at a level where it does not become detrimental to the body.

Preferably also, the inner surface and the outer surface of the cover are produced by co-extrusion. They are made from materials chosen among polyethylene, polypropylene and mixtures thereof.

Preferably again, the cover may comprise a cover strengthening layer, which acts to strengthen the cover, positioned between the above-mentioned inner and outer surfaces. This cover strengthening layer is preferably made from the same material as the inner and outer surfaces, and even more preferably from woven material.

Preferably, the cover consists of a first layer which acts as an inner surface which contacts the body and second layer which acts as an outer surface. The first layer is of an opaque dark color to minimize heat build up. The second layer is of an opaque pale color to deflect light.

Further preferably, the first and second layers of the cover are made from materials chosen among polyethylene, polypropylene and mixtures thereof.

Preferably again, the cover may comprise a third layer positioned between the above-mentioned first layer and the second layer. This third layer which acts as a strengthening layer is preferably made of a same material as the first and second layers and even more preferably of woven material.

Also preferably, the cover does not contain any perforations.

In certain exceptional circumstances however, the cover would contain perforations on its upper surface, i.e., the surface covering the top of the prism formation in which the sod is stacked, and/or on its sides. Such perforations could be used only if the composition of the soil in which the sod is grown has a higher than normal degree of microbial activity.

The objects and advantages of the present invention will become more apparent upon the reading of the following non-restrictive description of preferred embodiments thereof, given for the purpose of exemplification only, with reference to the accompanying drawings.

### BRIEF DESCRIPTION OF THE DRAWINGS

FIG. 1 is a schematic, perspective view of a cover according to a preferred embodiment of the invention which is positioned onto a skid to deflect light and minimize heat absorption.

FIG. 2 is a schematic, exploded perspective view of the cover of FIG. 1 showing its inner surface, its strengthening layer and its outer surface.

FIG. 3 is a perspective view of sod laid flat onto skids in a rectangular prism formation where at least one of the sod prisms laid flat onto the skid is not covered and most of the others are covered by a cover as shown in FIGS. 1 and 2.

### DETAILED DESCRIPTION OF THE INVENTION

In the following description, the same numerical references refer to similar elements. The embodiments shown in the figures are preferred, and are used for exemplification purposes only.

As aforesaid, although the cover according to the present invention was primarily designed for use with sod, it may be used with other types of turf or agricultural products, as apparent to a person skilled in the art. For this reason, expressions such as “sod”, “turf”, “cover” etc., as used herein should not be taken as to limit the scope of the present invention and include all other kinds of sod and/or agricultural products and/or items with which the present invention could be used and may be useful. In other words, although the present invention is primarily designed to cover sod, it could also be used as a covering for other objects, such as grain, hay, or vegetables, to name a few, as also apparent to a person skilled in the art. Thus, as aforesaid, expressions such as “sod”, etc. should not be taken as to limit the scope of the present invention and include all other objects with which the present invention could be used.

Moreover, in the context of the present description, the expressions “cover”, “sod”, “invention”, etc., and any other equivalent expression known in the art will be used interchangeably. Furthermore, the same applies for any mutually equivalent expressions, such as “covering” for example, as will also be apparent to a person skilled in the art.

More particularly, the present invention is essentially concerned with a cover devised to deflect light and to minimize the build up of heat on sod located under the cover, so as to increase the shelf-life of sod during its storage and transportation, and in addition, to contain the moisture within the sod at a level that will not hasten its decay. As such, the expression “to cover” should also be given the following meaning: “to provide a covering” and “to protect”.

In addition, although the preferred embodiment of the present invention illustrated in the accompanying drawings comprises specific components and geometrical configurations, not all of these components and geometries are essential to the invention and should thus not be taken in their restrictive sense. In other words, they should not be taken as to limit the scope of the present invention. As will be apparent to any one skilled in the art, other suitable components as well as other suitable geometrical configurations could be used for the cover and its corresponding parts according to the present invention.

The cover 1 according to the preferred embodiment of the invention, as illustrated in the accompanying drawings, is designed to cover a body 3 which is preferably sod. More specifically, the cover 1 is intended to be used to deflect light and to minimize the build up of heat under it, which could be absorbed by the body 3. As such, it will also maintain the moisture content of the sod as not to hasten its decay.

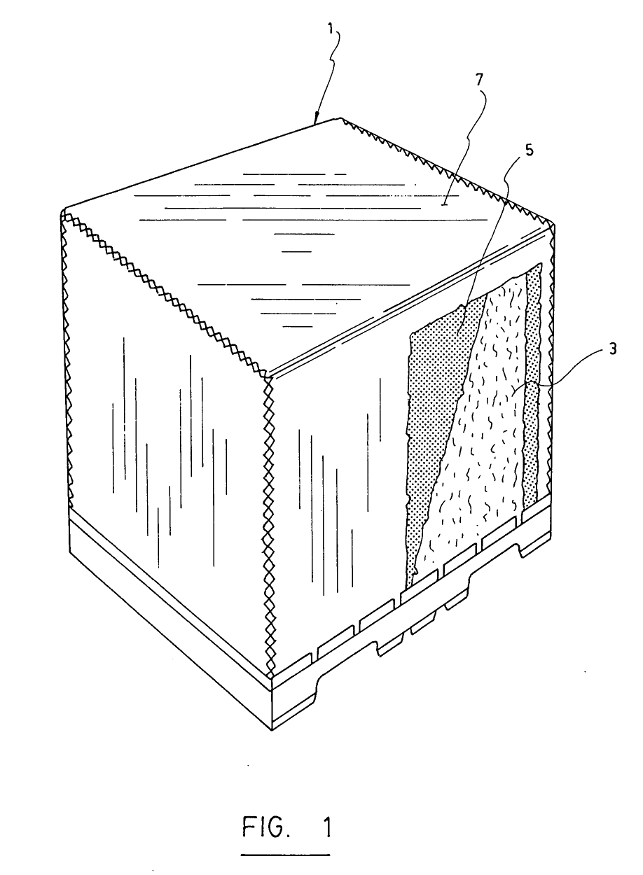

As is shown in FIG. 1, the cover 1 comprises an inner surface 5 which contacts the body 3, and an outer surface 7. The inner surface 5 is of an opaque dark color to minimize heat build up and the outer surface 7 is of an opaque pale color to deflect light.

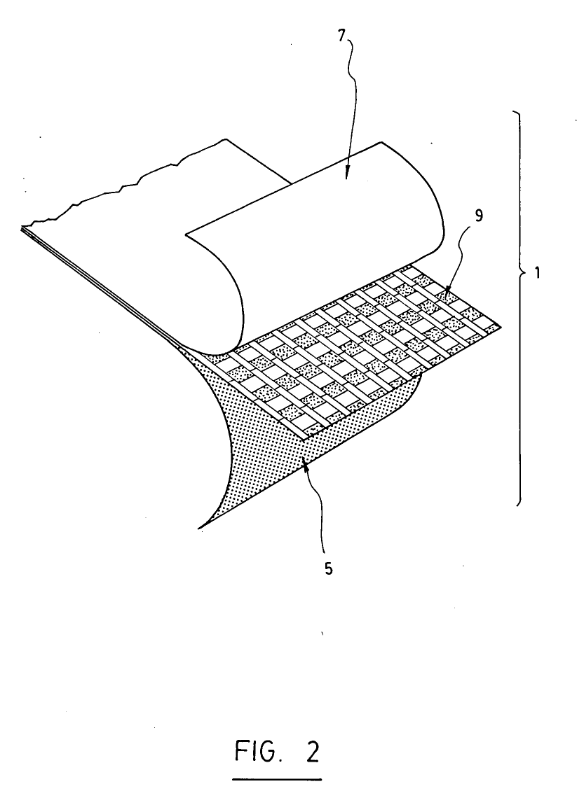

As shown in FIG. 2, the cover 1 comprises the inner surface which faces the outer surface 7. The inner surface 5 is opaque and dark in color, preferably black. The outer surface 7 is opaque and light in color, preferably white.

Preferably, as also shown in FIG. 2, the cover strengthening layer 9 is positioned as to be located between the inner surface 5 and the outer surface 7.

The inner and outer surfaces 5, 7 of the cover 1 are advantageously made from a material commonly used to make covers. The material is preferably chosen among woven polyethylene, non-woven polyethylene, woven polypropylene, non-woven polypropylene, and mixtures thereof. Also, extruded polyethylene or polypropylene films produced as a single sheet, or as a co-extruded sheet with different colors on each side, may be used. Any one skilled in the art will understand that the material that is used could actually consist of materials and polymers other than those mentioned herein, provided that they confer the same characteristics to the invention.

As aforesaid, the material that may be used to make the surfaces 5, 7 of the cover 1 may be polyethylene. It is known that polyethylene is a thermoplastic commodity heavily used in consumer products. Polyethylene is classified into several different categories based mostly on its density and branching. The mechanical properties of polyethylene depend significantly on variables such as the extent and type of branching, the crystal structure, and the molecular weight. It is also known that polyethylene substances can be classified according to many categories such as UHMWPE (ultra high molecular weight PE), HMWPE (high molecular weight polyethylene), HDPE (high density PE), HDXLPE (high density cross-linked PE), PEX (cross-linked PE), MDPE (medium density PE), LDPE (low density PE), LLDPE (linear low density PE), VLDPE (very low density PE). Other categories of polyethylene may also exist and are included in the scope of the invention. Of course, the surfaces 5, 7 of the cover 1 according to the invention may be made of polyethylene substances chosen among the polyethylene categories listed here above.

As also mentioned above, the material that may be used to make the surfaces 5, 7 of the cover 1 may be polypropylene. It is known that polypropylene is a thermoplastic polymer, used in a wide variety of applications, including food packaging, textiles, plastic parts and reusable containers of various types, laboratory equipment, loudspeakers, automotive components, and polymer banknotes. Furthermore, it is known that most commercial polypropylene has a level of crystallinity intermediate between that of low density polyethylene (LDPE) and high density polyethylene (HDPE). Other categories of polypropylene may exist and are included in the scope of the invention. Once again, the cover 1 according to the invention could be made of polypropylene chosen among polypropylene polymers, whether they are mentioned here above or not.

In other words, the cover 1 can be made of materials made of polyethylene or polypropylene of the woven or non-woven type such as those described here above. Alternatively, it can be made of a mixture of the above-mentioned materials.

The opaque dark color of the inner surface 5 and the opaque pale color of the outer layer 7 are obtained as part of the process of making the surfaces 5, 7. The surfaces 5, 7 are extrusion coatings which could preferably be made by a process called “extrusion”.

Concerning the process called “extrusion”, it is known that such a process is a coating process in which a molten substance is extruded and pressed onto or into the surface of a solid object or material so as to adhere to and coat this surface. The materials used in extrusion coating are of high viscosity, usually up to the millions of centipoises (absolute unit of viscosity), and do not wet the lips of the die, but flow as a ribbon out of the die. As such, the materials mentioned here-above are used in the extrusion process according to the invention.

Therefore, according to a preferred embodiment of the invention, the inner and outer surfaces 5, 7 could be made from a molten substance derived from polyethylene, polypropylene and mixtures thereof.

In accordance with another preferred embodiment of the invention, the inner surface 5 and the outer surface 7 are preferably obtained by a process called “co-extrusion”.

“Co-extrusion” involves the processing of two or more physically and chemically compatible materials which are extruded through multiple extruders into one die. Usually, co-extruded layers are produced in an extruder which can yield combined layers of various colors and films, or extrusion coatings, of at least two different thicknesses.

In accordance with a further preferred embodiment of the invention, the inner surface 5 and the outer surface 7 may be obtained by applying a laminated product to the cover strengthening layer 9 of the cover 1. The laminated product may be bonded to the cover strengthening layer 9 with an extrudate in order to result in the making of the inner surface 5 and the outer surface 7.

Therefore, according to the invention, the inner surface 5 and the outer surface 7 may be achieved by extrusion, co-extrusion or lamination using materials from any one of polyethylene, polypropylene, mixtures thereof or other polymers laid onto the surfaces 5, 7 of the cover 1, where the coating on the outer surface is of an opaque pale color and the coating on the inner surface is of an opaque dark color.

In all of these preferred embodiments, it is advantageous that the colors of both the inner surface 5 and the outer surface 7 be opaque since the use of non-opaque colors, particularly to cover sod, would not be advantageous. Indeed, a clear cover would increase the moisture of the sod, and would hasten the burning of the sod as it is exposed to the sun. Furthermore, the use of non-opaque colors would also result in increased condensation under the cover, and would consequently hasten the decay of the sod.

It is worth noting that, although a person in the art will know that, in general, a dark color has the property of being light absorbing and that a light color has the property of being light reflecting, it is not to be expected that a person in the art would come to the conclusion that designing a cover with a dark opaque color coating on the inside and a pale opaque color on the outside would minimize heat build-up within the covered body. Actually, an effect to the contrary would be expected.

Also, it is worth noting that the cover strengthening layer 9 can be made of the same material of the same family of polymers as the inner and outer surfaces 5, 7 of the cover 1. This is advantageous since the inner and outer surfaces 5, 7 will adhere better to the cover strengthening layer 9. Preferably however, the cover strengthening layer 9 is made of woven fibre scrim.

In all of the preferred embodiments mentioned herein above, the cover 1 which lacks perforations on the portion of the cover 1 which covers the side of the sod is preferred. Even more preferably, the cover 1 lacks perforations entirely. However, perforations may be utilized in covering sod produced with organic soil with high degrees of microbial activity. An example of such organic soil is commonly known as peat.

This advantageous feature would be surprising to a person skilled in the art since the absence of perforations would lead this person to think that the heat build-up inside the sod which is covered would be maximized, when in fact it is not, as shown in the Example provided herein below.

In accordance with another preferred embodiment, the cover 1 may comprise two layers, which two layers are a first layer which contacts the body 3, and a second layer which faces the first layer. The first and second layers are preferably made of material chosen among polyethylene, polypropylene and mixtures thereof.

Preferably, the first and second layers are coated with films. The film on the first layer acts as the inner surface 5 and the film on the second layer acts as the outer surface 7. The films are coatings preferably made of material chosen among polyethylene, polypropylene and mixtures thereof. The films are applied to the first and second layers by a process suitable to the purpose, and preferably by lamination. The film on the first layer is of an opaque dark color to minimize heat build up and the film on the second layer is of an opaque pale color to deflect light.

Preferably also, a third layer is positioned between the first layer and the second layer in order to strengthen the cover and acts as the cover strengthening layer 9. This third layer shares the features described for the cover strengthening layer described herein above.

### EXAMPLE

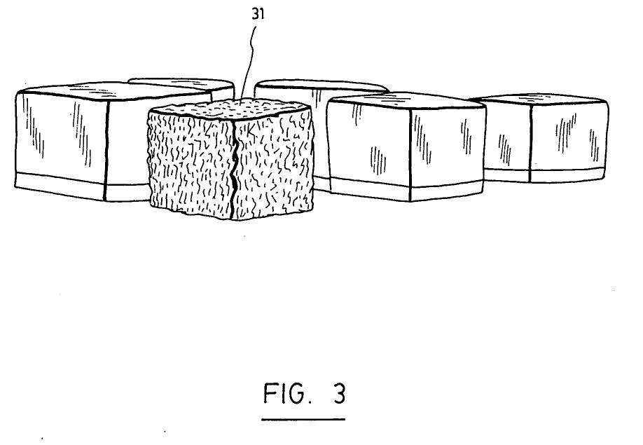

A trial was conducted at a farm in Florida, United States in order to test for lengthening of the shelf life of sod laid flat onto skids (see FIG. 3) and to test for the efficiency of covers according to the invention.

The control sod used during the trial was exposed sod laid out in a rectangular prism formation, in other words, a sod prism that was not covered throughout the duration of the trial. The control sod 31 was laid out in a rectangular prism formation, in sod prisms, as shown in FIG. 3.

The covers used for this particular trial were made from woven polyethylene fabric, with an opaque white coating on the outer surface and an opaque black coating on the inner surface.

Perforations of ¼ inch (0.64 cm) in diameter spaced about 6 inches (15.24 cm) apart were made in the cover, in the part of the cover which corresponds to the sides of the sod prism. No perforations were made in the part of the cover which was located on the top of the sod prism.

The size of the covers figured approximately around 53×53×36 inches (134.62 cm×134.62 cm×91.44 cm).

It should be noted that some non-woven fully breathable covers, i.e. covers with perforations on the sides and on the top, as well as some non-perforated covers were also tested, as well as combinations of the types of materials, both woven and non-woven.

The sod was harvested in the fields at approximately 10:30 a.m. and trucked to the marshalling area where sod is marshalled or placed onto skids in a prism formation prior to being loaded onto flat beds for further transportation.

The skids, on which the sod is laid onto for transportation, were placed about 4 feet (1.22 meters) apart. Indoor-outdoor thermometers were installed in several of the covered and uncovered skids. Thermometers probes were inserted about 6 inches (15.24 cm) down from the top and approximately 6 inches (15.24 cm) inside the sod prism and centered on the southern side of the skids to read inside and outside skid temperatures at the same time each day.

The covers according to the invention were placed over several rows of sod prisms laid onto skids. Each row had one skid on which was placed a sod prism that was used as a control, i.e. a sod prism, with no cover.

The covers of the sod placed on the skids were removed after 24, 48 and 72 hour time periods and the observations concerning the sod recorded. The observations relate to the condition of the sod on the visible layers of the sod as placed onto the skids as well as on the inside of the sod prism. Ambient temperatures and the temperatures inside the skids were also measured. For the ambient temperature, the sensor was in the reading device and was located under the skid and resting on the ground, that is, the part of the skid that is not in the sun.

The results of this trial are summarized in Table 1 below:

TABLE 1
Results of the Trial Testing the Efficiency of the Covers after
24, 48 and 72 Hours.

| | | Ambient | | Ambient | |
|---|---|---|---|---|---|
| | | Temperature | Observations | Temperature | Observations |
| | | Variation in the | Concerning the | Variation in the | Concerning |
| | Moisture | Sod with the | Sod with the | Control Sod | the Control |
| Hours | content | Cover (° C.) | Cover | (° C.) | Sod |
| 0 | 50% | 82.5 to 100.4 | Looks great | 80.8 to 89.6 | Edges and top |
| | | | | | layer drying |
| 24 | 37% | 91.0 to 93.3 | Top layer looks | 82.9 | Top layer dead, |
| | | | great, but the | | and the inside |
| | | | lower layers are | | is turning |
| | | | starting to yellow | | yellow |
| 48 | 81% | 97.5 to 84.7 | Top layer looks | 82.8 to 85.5 | Top layer has |
| | | | great, but the | | dead or drying |
| | | | lower layers are | | edges. The |
| | | | starting to turn | | inside is turning |
| | | | yellow | | yellow. |
| | | | | | Mostly not in |
| | | | | | condition for |
| | | | | | sale |
| 72 | 70% | 102.2 to 87.0 | Top layer | 83.9 to 84.9 | Completely dry |
| | | | becoming slightly | | and yellow. |
| | | | distressed and | | Not in condition |
| | | | the lower layer is | | for sale |
| | | | turning yellow. | | |
| | | | All sod still in | | |
| | | | condition for sale | | |

The covers with no perforations on the part of the cover covering the top of the sod prism and with perforations on the parts of the cover covering the sides of the sod prism proved to extend the sod's shelf life by 3 days.

The results show that there was actually a reduction of heat of the covered sod prism, of 10° to 15° after 48 hour exposure, and even after 72 hours of exposure.

It is to be noted that the exact extent of the visible shelf-life extension may depend on other factors including quantities of fertilizer used, placement of sod in relation to the sun, and varying weather conditions, for example.

In addition, based on the confirming results of this trial, along with the results of another trial (results not shown), it is believed that non-perforated covers according to the invention outperform covers with perforated sides and outlast sod that has not been covered.

Although a preferred embodiment of the present invention has been described in detail herein and illustrated in the accompanying drawings, it is to be understood that the invention is not limited to this embodiment and that various changes and modifications could be made without departing from the scope and spirit of the present invention.

1. A cover to be positioned onto a body to deflect light, to minimize heat absorption by and to retain the moisture of said body, said cover comprising an inner surface which contacts the body and an outer surface, wherein the inner surface is of an opaque dark color to minimize heat build up and the outer surface is of an opaque pale color to deflect light.

2. The cover according to claim 1, characterized in that the inner surface and the outer surface are produced by co-extrusion.

3. The cover according to claim 2, characterized in that the inner surface and the outer surface are made from materials chosen among polyethylene, polypropylene and mixtures thereof.

4. The cover according to claim 3, characterized in that the materials are woven or non-woven.

5. The cover according to claim 1, characterized in that a cover strengthening layer is positioned between the inner surface and the outer surface.

6. The cover according to claim 5, characterized in that the cover strengthening layer is made from materials that are the same as those chosen for the making of the inner and outer surfaces.

7. The cover according to claim 6, characterized in that the materials are woven.

8. A cover to be positioned onto a body to deflect light, to minimize heat absorption by and to retain the moisture of said body, said cover comprising a first layer which acts as an inner surface and contacts the body, and a second layer which acts as an outer surface, the inner surface being of an opaque dark color to minimize heat build up and the outer surface being of a opaque pale color to deflect light.

9. The cover according to claim 8, characterized in that the first and second layer are made from materials chosen among polyethylene, polypropylene and mixtures thereof.

10. The cover according to claim 8, characterized in that the first and second layer are made by lamination or extrusion.

11. The cover according to claim 8, characterized in that the cover has a third layer positioned between the first layer and the second layer in order to strengthen the cover.

12. The cover according to claim 11, characterized in that the third layer is made from materials that are the same as those chosen for the making of the first and second layers.

13. The cover according to claim 12, characterized in that the materials are woven.

14. The cover according to claim 1, characterized in that the body is sod or a harvested agricultural product.

15. The cover according to claim 14, characterized in that the harvested agricultural product is chosen among the group comprising hay, vegetables and grain.

16. The cover according to claim 8, characterized in that the body is sod or a harvested agricultural product.

17. The cover according to claim 16, characterized in that the harvested agricultural product is chosen among the group comprising hay, vegetables and grain.

18. The cover according to claim 1, characterized in that the body has a prism-like form, wherein the form has a lower surface on which the body rests, an upper surface opposite the lower surface, and a side surface between the lower surface and the upper surface, and wherein the cover covering the side surface and/or the upper surface contains perforations.

19. The cover according to claim 8, characterized in that the body has a prism-like form, wherein the form has a lower surface on which the body rests, an upper surface opposite the lower surface, and a side surface between the lower surface and the upper surface, and wherein the cover covering the side surface and/or the upper surface contains perforations.
